(19) United States
(12) Patent Application Publication
(10) Pub. No.: US 2024/0392927 A1
(43) Pub. Date: Nov. 28, 2024

(54) CRYOGENIC TANK

(71) Applicant: Andreas Zieger, Hofstätten an der Raab (AT)

(72) Inventor: Johannes ZIEGER, Hofstätten an der Raab (AT)

(21) Appl. No.: 18/695,710

(22) PCT Filed: Sep. 23, 2022
(86) PCT No.: PCT/EP2022/076470

§ 371 Date: Mar. 26, 2024

(30) Foreign Application Priority Data
Sep. 27, 2021 (AT) GM 91/2021

(51) Int. Cl. F17C 13/04

(52) U.S. Cl. CPC F17C 13/04; F17C 2203/03; F17C 2205/0326; F17C 2205/0335; F17C 2205/0385; F17C 2205/0394; F17C 2221/012; F17C 2221/033; F17C 2223/0161; F17C 2265/065; F17C 2270/0168

(57) ABSTRACT

A cryogenic tank with an internal tank configured to receive a cryogenic fuel, an external tank that delimits an insulation chamber having insulation between the internal tank and the external tank to reduce the heat input into the internal tank and a thermally insulated filler neck to accommodate a fueling coupling on the side of the vehicle, and the cryogenic tank includes a cryogenic valve arranged within the filler neck configured to guide the fuel flow during fueling and/or retrieval, which is arranged in a compartment accessible via the filler neck and may be removed upon removal of the fueling coupling on the side of the vehicle.

### PRIOR ART

The invention relates to a cryogenic tank, in particular a cryogenic tank for receiving cryogenic hydrogen and supplying a consumer with gaseous hydrogen according to the preamble of claim 1.

A fuel supply system for cryogenic fuels such as, e.g. LNG (natural gas) or LH₂ (hydrogen) comprises in general a two-wall container having an internal tank to receive the fuel, an external tank having insulation arranged therebetween to reduce the heat input into the internal tank, an internal tank suspension to position the internal tank within the external tank, a thermally insulated filler neck (Johnson Cox coupling) at the external tank to accommodate the fueling coupling on the side of the vehicle with valves, switching components to control the mass flow during fueling, switching components to control the mass flow during retrieval, switching components to delimit the internal tank pressure, a heat exchanger and associated switching components to maintain the internal tank pressure, a heat exchanger to heat the fuel for the consumer, lines to connect the individual switching components and heat exchangers and sensors to control the mass flows, for monitoring and diagnostics.

Such fuel storage systems for cryogenic fuels have been known, for example, from DE 19546618, DE 102009012380, DE 19945462, DE 102008063563, DE 4041170, DE 00001981744, DE 4320556, WO 2009/071208 and the like, wherein the individual applications differ from one another, for example, in regard to the fueling process, i.e. fueling with or without return of gas from the internal tank to the filling station, in regard to the pressure level, i.e. subcritical and/or supercritical fueling and storage of the fuel, in regard to the switching systems, i.e. type, number and arrangement of the switching components for fueling, for retrieval and for relieving pressure. A common feature of all applications is the arrangement of the cryogenic switching components to control the fueling process and to control the retrieval process in a thermally insulated chamber, preferably in the intermediate space between the internal tank and the external tank or in a valve box releasably or rigidly connected to the external tank, which is connected to the pipeline system to the internal tank. This configuration ensures that there will not occur any liquefaction of the air during fueling and during retrieval.

The disadvantages of cryogenic switching valves as, for example, shown in EP 1801478, are the enormous space requirements of the valve to prevent liquefaction or condensation at the external surface, the high costs of the individual cryogenic valve and the fuel supply system in the case of several valves being used, the costs for shrink-wrapping the valve housing and the welding of the connection lines to the valve as well as examination of the weld seams, discontinuation and reduction of the insulation effect in the case of arrangement of the cryogenic valve/s within the insulation chamber between the internal tank and the external tank, and the weight.

### Technical Problem

The problem of the invention is to prevent the disadvantages of prior art, in particular the weight, the dimensions and the costs of a cryogenic fuel supply facility are thus reduced due to components being eliminated, work process steps being eliminated and examination processes being eliminated.

According to the invention, the present problem is solved by providing a cryogenic tank having the features of claim 1.

### Technical Solution

The problem is solved by the arrangement of the cryogenic valves or the cryogenic switching components, respectively, for controlling the fuel flow during fueling and/or for controlling the fuel flow during retrieval in various embodiment variants in a chamber directly or indirectly connected to the filler neck, wherein all cryogenic valves are releasable upon removal of the fueling coupling on the side of the vehicle, i.e. the arrangement of the cryogenic valves is realized in the filler neck or in a chamber accessible via the filler neck or arranged upstream or downstream of the filler neck in the direction of fueling or at or in, respectively, the fueling coupling on the side of the vehicle. The task is further solved by the preferable use of cryogenic check valves and optionally a cryogenic internal tank pressure control valve instead of electromechanical cryogenic, electro-pneumatic cryogenic or electro-hydraulic cryogenic shutoff valves.

The filler neck of the cryogenic neck is a tubular component, the external tank-sided end of which is welded to the external tank and the internal tank-sided end thereof is welded to the filling line and, if present, to the gas return line. The fueling coupling on the side of the vehicle is attached at the external tank-sided end of the filler neck and extends through the central tubular part of the filler neck up to the internal tank-sided end of the filler neck, wherein there is realized at the end of the internal tank side of the filler neck a connection of the corresponding lines. The fueling coupling on the side of the vehicle accommodates the fueling coupling on the side of the filling station during fueling and comprises valves for fueling. The central tubular part of the fueling coupling is configured to have a lower wall width to prevent condensation or liquefaction.

The cryogenic valves are preferably combined into a compact valve block, wherein the valve block preferably forms the housing for all switching valves and wherein bores in the valve block preferably replace the welded lines according to prior art and connect the individual switching component. Due to the configuration, a line preferably welded to the valve block and the internal tank connects the valve block to the internal tank, wherein the remaining corresponding lines between the valve block and the internal block are each connected by an interlock or screw system and arranged within the welded line.

Optionally, there are further arranged within the welded line also lines of the pressure maintenance system for the internal tank and/or lines of the pressure relief system for the internal tank.

Optionally, the shutoff valve towards the consumer is arranged at the valve block or in the filler neck.

Optionally, the valves for relieving the internal tank pressure are arranged at the valve block or in the filler neck.

Optionally, the valves for maintaining the internal tank pressure are arranged at the valve block or in the filler neck.

Optionally, the heat exchanger for heating the fuel for the consumer is arranged at the valve block or in the filler neck.

Optionally, the valve block or the filler neck comprises all necessary valves of the cryogenic tank and optionally accommodates the heat exchanger for heating the fuel as well as the fueling coupling on the side of the vehicle.

The cryogenic valves form a handable array due to the compact configuration and arrangement, thus simplifying mounting and pre-examination thereof.

Due to the arrangement of the cryogenic switching components in a chamber, which is accessible via the filler neck, each valve seat may be exchanged on demand.

Due to the arrangement of the cryogenic switching components in a chamber, which is accessible via the filler neck, shrink-wrapping of the housing for the switching components in the external tank and examination of the weld seams is eliminated.

Due to the arrangement of the cryogenic switching components in a chamber, which is accessible via the filler neck, individual connection lines between the components as well as the weldings and the examinations of the weld seams are eliminated.

Due to the arrangement of the cryogenic switching components in a chamber, which is accessible via the filler neck, the risk of a decrease in insulation quality due to leaking connection points is reduced.

Due to the arrangement of the cryogenic switching components in a chamber, which is accessible via the filler neck, insulation will not be discontinued and the insulation effect will be improved.

Due to the elimination of the housings for the individual cryogenic valves, the weight of the cryogenic tank is reduced.

Due to the arrangement of the cryogenic switching components in a chamber, which is accessible via the filler neck, the risk of icing is reduced.

Due to the arrangement of the cryogenic switching components in a chamber, which is accessible via the filler neck, there is achieved substantial cost reduction due to the elimination of components and due to the elimination of work and examination processes.

Due to the use of check valves and pressure switches instead of electromechanical or electro-pneumatic, respectively, or electro-hydraulic cryogenic shutoff valves, there is only necessary in the entire cryogenic fuel supply facility only one preferably electromechanical shutoff valve in the flow direction downstream of the heat exchanger.

### DESCRIPTION OF THE FIGURES

The cryogenic tank according to the invention as well as alternative embodiment variants are explained in the following by way of the figures.

FIG. 1 shows a cryogenic tank according to the invention in a preferred embodiment for a single-flow fueling using a check valve.

FIG. 2 shows the cryogenic tank according to the invention in an alternative embodiment variant for a single-flow fueling using a check valve and an internal tank pressure control valve.

FIG. 3 shows another alternative embodiment variant of the cryogenic tank according to the invention for a dual-flow fueling using a check valve and an unlockable check valve.

FIG. 4 shows another alternative embodiment variant of the cryogenic tank according to the invention for a dual-flow fueling using a check valve, an unlockable check valve and an internal tank pressure control valve.

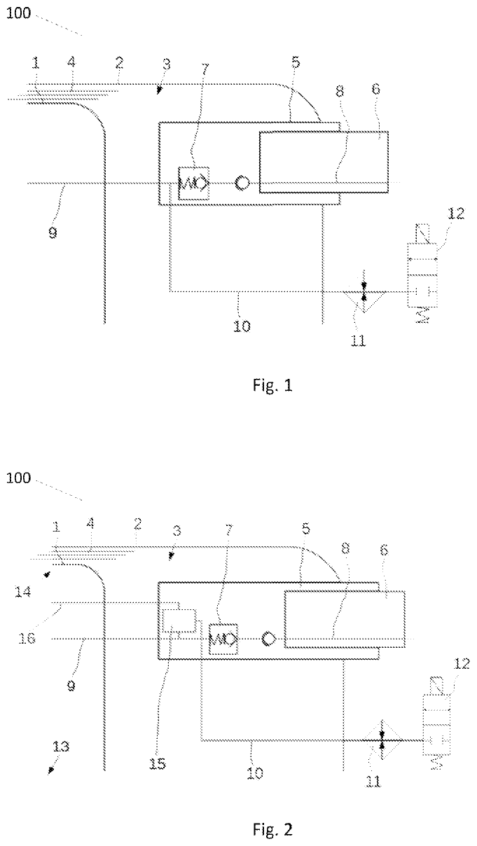

FIG. 1 shows a section of a cryogenic tank 100 for a single-flow fueling without gas return to the filling station, comprising an internal tank 1 to receive the cryogenic fuel at a determined pressure or at a determined temperature, respectively, an external tank 2 to delimit the insulation chamber 3 between the internal tank 1 and the external tank 2 having insulation 4 to reduce the heat input into the internal tank 1 and a filler neck 5 in a Johnson Cox configuration to accommodate the fueling coupling 6 on the side of the vehicle. There is arranged in the filler neck 5 a check valve 7, which opens during fueling due to the fueling flow, closes the internal tank 1 in the driving operation and enables pressure relief into the internal tank 1. The inlet of the check valve 7 is connected to the filling line 8 of the fueling coupling 6 on the side of the vehicle, and the outlet of the check valve 7 is connected to a fueling and retrieval line 9 terminating in the internal tank 1 for filling and for retrieval as well as to a retrieval line 10 to the heat exchanger 11 for heating the cryogenic fuel and downstream of an electromagnetic shutoff valve 12 for closing the retrieval line in the idle state. The cryogenic valve may be preferably configured as a cryogenic check valve 7 or as an electromechanical cryogenic shutoff valve. In addition, the cryogenic valve may be configured to being opened due to the fuel flow during fueling.

During fueling, the cryogenic fuel will flow, due to a pressure difference, between the filling station and the internal tank 1 via the check valve 7 pushed into the opened position into the internal tank 1. Upon completion of fueling, the check valve 7 will automatically close. During retrieval, the cryogenic fuel will flow, due to a pressure difference between the internal tank 1 and the consumer, across the heat exchanger 11 and the shutoff valve 12 opened due to the flow out of the internal tank 1 and will be heated in the heat exchanger 11. The check valve 7 is closed during retrieval. The shutoff valve 12 is only open when the consumer is supplied with fuel.

The fueling path for filling the internal tank 1 between the fueling coupling 6 on the side of the vehicle and the internal tank 1 comprises, together with the cryogenic check valve 7, a cryogenic switching component. The retrieval path for emptying the internal tank 1 between the internal tank 1 and the feed line to the consumer comprises, together with the electromagnetic shutoff valve 12, a non-cryogenic switching component.

The cryogenic tank 100 may be filled with supercritical cryogenic fuel, i.e. fuel in the supercritical state, or with liquid cryogenic fuel, wherein no gaseous cryogenic fuel will return to the filling station. If the fueling and retrieval line 9 terminates at the bottom side 13 of the internal tank 1, upon supercritical fueling, depending on the heat capacity of an internal tank heat exchanger, supercritical cryogenic and/or liquid cryogenic fuel will be retrieved. If the fueling and retrieval line 9 terminates at the bottom side 13 of the internal tank 1, upon subcritical fueling, there will be retrieved predominantly liquid cryogenic fuel. If the fueling and retrieval line 9 terminates at the top side 14 of the internal tank 1, upon supercritical fueling, depending on the heat capacity of an internal tank heat exchanger, supercritical cryogenic and/or gaseous cryogenic fuel will be retrieved. If the fueling and retrieval line 9 terminates at the top side 14 of the internal tank 1, upon subcritical fueling, there will be retrieved gaseous cryogenic fuel.

Preferably, the check valve 7 is arranged at the end of the filler neck 5 at the side of the internal tank and accessible upon removal of the fueling coupling 6 on the side of the vehicle. Optionally, the check valve 7 is arranged in a space downstream of the end of the filler neck 5 on the side of the internal tank in the fueling direction and connected to the filler neck 5 and accessible via the filler neck 6 upon removal of the fueling coupling 6 on the side of the vehicle. Optionally, the check valve 7 is arranged in a space upstream of the end of the filler neck 5 on the side of the internal tank in the fueling direction or at or in, respectively, the fueling coupling on the side of the vehicle and accessible upon removal the fueling coupling 6 on the side of the vehicle. Optionally, the check valve 7 is arranged in a separate, thermally insulated and tubular part, which is connected to the external tank, and accessible via the tubular part.

Preferably, retrieval is carried out via the fueling and retrieval line 9 and the retrieval line 10. Optionally, retrieval is carried out via a separate retrieval line between the internal tank 1 and the outlet of the check valve 7 or a separate retrieval line between the internal tank 1 and the heat exchanger 11.

Optionally, an electromechanical shutoff valve will replace the check valve 7.

Preferably, the shutoff valve 12 is arranged downstream of the heat exchanger, optionally the shutoff valve 12 is arranged upstream of the heat exchanger, preferably in the area of the cryogenic valves.

Preferably, fueling is carried out with supercritical cryogenic fuel, optionally fueling is carried out with liquid cryogenic fuel.

FIG. 2 shows an alternative embodiment variant of the cryogenic tank 100 according to the invention with a section of a cryogenic tank 100 for a single-flow fueling without gas return to the filling station comprising an international tank 1 to receive the cryogenic fuel at a determined pressure or at a determined temperature, respectively, an external tank 2 to delimit the insulation chamber 3 between the internal tank 1 and the external tank 2 with insulation 4 to reduce the heat input into the internal tank 1 and a filler neck 5 in Johnson Cox configuration to accommodate the fueling coupling 6 on the side of the vehicle. In the filler neck 5, there is arranged a check valve 7, which opens during fueling due to the fueling flow, closes the internal tank 1 during driving operation and enables pressure relief towards the internal tank 1. The inlet of the check valve 7 is connected to the filling line 8 of the fueling coupling 6 on the side of the vehicle, and the outlet of the check valve 7 is connected to a fueling and retrieval line 9 terminating in the internal tank 1 and intended for filling and retrieval. In the filler neck 5, there is further arranged an internal tank pressure control valve 15 for retrieval and connected to the fueling and retrieval line 9 at and a retrieval line 16 terminating in the internal tank 1 on the side of the inlet and to the retrieval line 10 at the side of the outlet to the heat exchanger 11, wherein the fueling and retrieval line 9 to retrieve liquid cryogenic fuel terminates at the bottom side 13 of the internal tank 1 and has an appropriate bore and the retrieval line 16 terminates at the top side 14 of the internal tank 1. The heat exchanger 11 heats the cryogenic fuel, and the electromagnetic shutoff valve 12 arranged downstream closes the retrieval line 10 in the idle state.

The internal tank pressure control valve 15 is a switching element, which has been known from LNG tanks, and provides, in the case of internal tank pressures above a determined change-over pressure of the internal tank pressure control valve 15, for the retrieval of gaseous cryogenic or supercritical cryogenic, respectively, fuel and, in the case of internal tank pressures below a determined change-over pressure of the internal tank pressure control valve 15, for the retrieval of liquid cryogenic or supercritical cryogenic, respectively, fuel.

During fueling, the cryogenic fuel will flow due to a pressure difference between the filling station and the internal tank 1 via the opened check valve 7 into the internal tank 1. Upon completion of fueling, the check valve 7 will close automatically. During retrieval, the cryogenic fuel will flow due to a pressure difference between the internal tank 1 and the consumer in dependency on the pressure within the internal tank 1 via the filling and retrieval line 9 or the retrieval line 16, the internal tank pressure control valve 15, the heat exchanger 11 and the opened shutoff valve 12 from the internal tank 1 and will be heated in the heat exchanger 11. The check valve 7 is closed during retrieval. The shutoff valve 12 is only open when the consumer is supplied with fuel.

The fueling path for filling the internal tank 1 between the fueling coupling 6 on the side of the vehicle and the internal tank 1 comprises with the cryogenic check valve 7 a cryogenic switching component. The retrieval path for emptying the internal tank 1 between the internal tank 1 and the feed line to the consumer comprises with the cryogenic internal tank pressure control valve 15 a cryogenic switching component and with the electromagnetic shutoff valve 12 a non-cryogenic switching component.

The cryogenic tank 1 may be filled with supercritical cryogenic fuel or with liquid supercritical fuel, wherein no gaseous cryogenic fuel will return to the filling station.

Upon supercritical fueling, depending on the heat capacity of the internal tank heat exchanger, there will be retrieved supercritical cryogenic and/or liquid cryogenic fuel in the case of internal tank pressures below the switching point of the internal tank pressure control valve 15. Upon supercritical fueling, there will be retrieved gaseous cryogenic fuel in the case of internal tank pressures above the switching point of the internal tank pressure control valve 15. Upon subcritical fueling, there will be retrieved liquid cryogenic fuel in the case of internal tank pressures below the switching point of the internal tank pressure control valve 15. Upon subcritical fueling, there will be retrieved gaseous cryogenic fuel in the case of internal tank pressures above the switching point of the internal tank pressure control valve 15.

Preferably, the check valve 9 and the internal tank pressure control valve 15 are arranged at the end of the filler neck 5 on the side of the internal tank and accessible upon removal of the fueling coupling 6 on the side of the vehicle. Optionally, the check valve 7 and the internal tank pressure control valve 15 are arranged in a chamber downstream of the end of the filler neck 5 on the side of the internal tank in the fueling direction and connected to the filler neck 5 and accessible via the filler neck 5 upon removal of the fueling coupling 6 on the side of the vehicle. Optionally, the check valve 7 and the internal tank pressure control valve 15 are arranged in a chamber upstream of the end of the filler neck 5 on the side of the internal tank in the fueling direction or at the fueling coupling 6 on the side of the vehicle and accessible upon removal of the fueling coupling 6 on the side of the vehicle. Optionally, the check valve 7 and the internal tank pressure control valve 15 are arranged in a separate and thermally insulated tubular part, which is connected to the external tank, and accessible via the tubular part.

Preferably, the internal tank pressure control valve 15 is connected to the fueling and retrieval line 9. Optionally, the internal tank pressure control valve 15 is connected to a separate retrieval line from the internal tank 1.

Optionally, an electromagnetic shutoff valve will replace the check valve 7, wherein the retrieval line 10 is arranged in the fueling direction upstream or downstream of the electromechanical shutoff valve.

Optionally, an electromechanical 2/2-way valve will replace the mechanic internal tank pressure control valve 15.

Optionally, an electromagnetic 3/2-way valve or an electromechanical 3/3-way valve will replace the check valve 7 and the internal tank pressure control valve 15, wherein the retrieval line 10 in the fueling direction will branch off upstream or downstream of the way valve.

Preferably, the shutoff valve 12 is arranged downstream of the heat exchanger, optionally the shutoff valve 12 is arranged upstream of the heat exchanger, preferably in the area of the cryogenic valves.

Preferably, fueling is carried out with supercritical cryogenic fuel, optionally fueling is carried out with liquid cryogenic fuel.

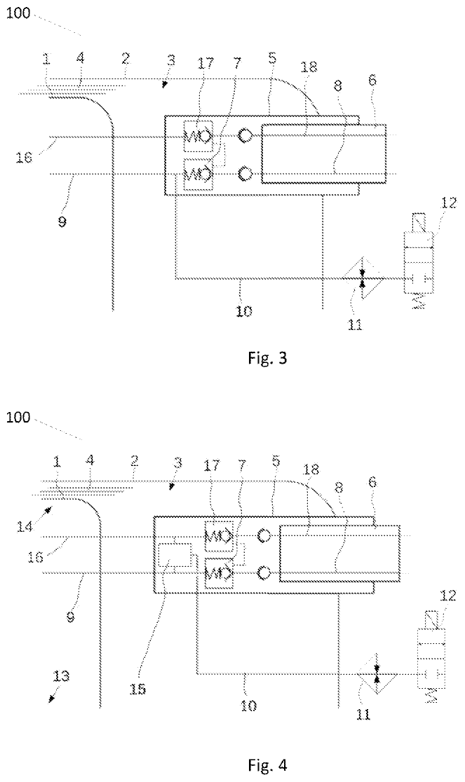

FIG. 3 shows an alternative embodiment variant of the cryogenic tank 100 according to the invention with a section of a cryogenic tank 100 for dual-flow fueling with gas return to the filling station, comprising an internal tank 1 to receive the cryogenic fuel at a determined pressure or temperature, respectively, an external tank 2 to delimit the insulation chamber 3 between the internal tank 1 and the external 2 with insulation 4 to reduce the heat input into the internal tank 1 and a filler neck 5 in Johnson Cox configuration to accommodate the fueling coupling 6 on the side of the vehicle. There is arranged in the filler neck 5 a check valve 7, which opens during fueling due to the fueling flow, closes the internal tank 1 in the driving operation and enables pressure relief towards the internal tank 1. The inlet of the check valve 7 is connected to the filling line 8 of the fueling coupling 6 on the side of the vehicle, and the outlet of the check valve 7 is connected to a fueling and retrieval line 9 terminating in the internal tank 1 for filling and for liquid retrieval. In the filler neck 5 there is further arranged an unlockable check valve 17, which opens during fueling due to the pressure within the fueling line or due to a mechanic coupling with the check valve 7 due to the opening movement of the sealing element in the check valve 7 and in this way provides for the return of gas from the internal tank 1 to the filling station, closes the internal tank 1 in the driving operation and enables pressure relief from the filler neck 5 towards the internal tank 1. The inlet of the unlockable check valve 17 is connected to the return gas line 18 of the fueling coupling 6 on the side of the vehicle, and the outlet of the unlockable check valve 17 is connected to a retrieval line 16 terminating in the internal tank 1 for the retrieval of gas. Furthermore, there is provided a retrieval line 10 to the heat exchanger 11, which connects the outlet of the check valve 7 to the inlet of the heat exchanger 11 for the retrieval of liquid. The heat exchanger 11 heats the cryogenic fuel, and the subsequently arranged electromagnetic shutoff valve 12 closes the retrieval line 10 in the idle state.

During fueling, the liquid cryogenic fuel will flow due to a pressure difference between the filling station and the internal tank 1 via the opened check valve 7 into the internal tank 1, and the gaseous cryogenic fuel will flow due to a pressure difference between the internal tank 1 and the filling station via the unlocked and thus opened unlockable check valve 17 to the filling station. Upon completion of fueling, the check valve 7 and thus also the unlockable check valve 17 will close automatically. During retrieval, the liquid cryogenic fuel will flow due to a pressure difference between the internal tank 1 and the consumer via the heat exchanger 11 and the opened shutoff valve 12 out of the internal tank 1 and will be heated in the heat exchanger 11. The check valve 7 and the unlockable check valve 17 are closed during retrieval. The shutoff valve 12 is only opened if the consumer is supplied with fuel.

The fueling path for filling the internal tank 1 between the fueling coupling 6 on the side of the vehicle and the internal tank 1 comprises with the cryogenic check valve 7 and the unlockable cryogenic check valve 17 two cryogenic switching components. The retrieval path for emptying the internal tank 1 between the internal tank 1 and the feed line to the consumer comprises with the electromagnetic shutoff valve 12 a non-cryogenic switching component.

The cryogenic tank 1 may be filled with liquid cryogenic fuel, wherein gaseous cryogenic fuel fill return to the filling station.

After fueling, depending on the heat capacity of the internal tank heat exchanger, there will be retrieved liquid cryogenic and then gaseous cryogenic fuel.

Preferably, the check valve 7 and the unlockable check valve 17 are arranged at the end of the filler neck 5 at the side of the internal tank and accessible after removal of the fueling coupling 6 on the side of the vehicle. Optionally, the check valve 7 and the unlockable check valve 17 are arranged in a chamber in the fueling direction downstream of the end of the filler neck 5 on the side of the internal tank and connected to the filler neck 5 and accessible after removal of the fueling coupling 6 on the side of the filler neck 5 via the filler neck 5. Optionally, the check valve 7 and the unlockable check valve 17 are arranged in the fueling direction upstream of the end of the filler neck 5 on the side of the internal tank or at or in, respectively, the fueling coupling 6 on the side of the vehicle and accessible after removal of the fueling coupling 6 on the side of the vehicle. Optionally, the check valve 7 and the unlockable check valve 17 are arranged in a separate thermally insulated and tubular part, which is connected to the external tank, and accessible via the tubular part.

Preferably, the retrieval of liquid cryogenic fuel is carried out via the fueling and retrieval line 9. Optionally, the retrieval of liquid cryogenic fuel is carried out via a separate retrieval line between the internal tank 1 and the outlet of the check valve 7 or a separate retrieval line between the internal tank 1 and the heat exchanger 11. Optionally, the retrieval of gaseous cryogenic fuel is carried out via the retrieval line 16 and the retrieval line 10, for which purpose the retrieval line 10 connects the inlet of the unlockable check valve 17 instead of the outlet of the check valve 7 to the inlet of the heat exchanger 11. Optionally, the retrieval of gaseous cryogenic fuel is carried out via a separate retrieval line between the internal tank 1 and the inlet of the unlockable check valve 17 or a separate retrieval line between the internal tank 1 and the heat exchanger 11.

Optionally, an electromechanical shutoff valve will replace the check valve 7.

Optionally, an electromechanical shutoff will replace the unlockable check valve 17.

Optionally, a 4/3-way valve will replace the check valve 7 and the unlockable check valve 17.

Preferably, the shutoff valve 12 is arranged downstream of the heat exchanger, optionally the shutoff valve 12 is arranged upstream of the heat exchanger, preferably in the area of the cryogenic valves.

Preferably, fueling is carried out with liquid cryogenic fuel, optionally fueling is carried out with supercritical cryogenic fuel. The cryogenic tank 100 comprises thus according to an embodiment variant a cryogenic check valve for guiding a fuel flow in the liquid or supercritical aggregate state during fueling from a filling station into the internal tank 1, wherein the check valve 7 is opened during fueling and wherein the check valve 7 is closed during retrieval. In addition, the cryogenic tank 100 may comprises an electromechanical cryogenic shutoff valve to guide a fuel flow in the liquid or supercritical aggregate state during fueling from a filling station into the internal tank 1, wherein the electromechanical cryogenic shutoff valve is opened during fueling and optionally during retrieval.

FIG. 4 shows an alternative embodiment variant of the cryogenic tank 100 according to the invention with a section of a cryogenic tank 100 for a dual-flow fueling with gas return to the filling station, comprising an internal tank 1 to receive the cryogenic fuel at a determined pressure or at a determined temperature, respectively, an external tank 2 to delimit the insulation space 3 between the internal tank 1 and the external tank 2 having insulation 4 to reduce the heat input into the internal tank 1 and a filler neck 5 in Johnson Cox configuration to accommodate the fueling coupling 6 on the side of the vehicle. In the filler neck 5, there is arranged a check valve 7, which opens during fueling due to the fueling flow, closes the 9 internal tank 1 during the driving operation and enables pressure relief to the internal tank 1. The inlet of the check valve 7 is connected to the filling line 8 of the fueling coupling 6 on the side of the vehicle, and the outlet of the check valve 7 is connected to a fueling and retrieval line 9 terminating in the internal tank 1 for fueling and retrieval of liquid. In the filler neck 5, there is arranged an unlockable check valve 17, which opens during fueling due to the pressure in the fueling line or opens due to a mechanical coupling with the check valve 7 due to the opening movement of the sealing element in the check valve 7 and in this way enables the return of gas from the internal tank 1 to the filling station as well as closes the internal tank in the driving operation and provides for pressure relief from the filler neck 5 into the internal tank 1. The inlet of the unlockable check valve 17 is connected to the return gas line 18 of the fueling coupling 6 on the side of the vehicle, and the outlet of the unlockable check valve 17 is connected to a retrieval line 16 terminating in the internal tank 1 for the retrieval of gas. In the filler neck 5, there is further arranged an internal tank pressure control valve 15 for retrieval and connected on the side of the inlet to the fueling and retrieval line 9 and a retrieval line 18 terminating in the internal tank 1 and on the side of the outlet to a retrieval line 10 to the heat exchanger 11, wherein the fueling and retrieval line 9 terminates at the bottom side 13 of the internal tank 1 or has an appropriate bore and the retrieval line 18 terminates at the top side 14 of the internal tank 1. The heat exchanger 11 heats the cryogenic fuel, and the electromagnetic shutoff valve 12 arranged downstream closes the retrieval line 10 in the idle state.

The internal tank pressure control valve 15 is a switching element, which has been known from LNG tanks and provides, in the case of internal pressures above a determined change-over pressure of the internal tank pressure control valve 15, for the retrieval of gaseous fuel and, in the case of internal tank pressures below a determined change-over pressure of the internal tank pressure control valve 15, for the retrieval of liquid fuel.

During fueling, the liquid cryogenic fuel will flow due to a pressure difference between the filling station and the internal tank 1 via the opened check valve 7 into the internal tank 1 and the gaseous cryogenic fuel will flow due a pressure difference between the internal tank 1 and the filling station via the unlocked and thus opened unlockable check valve 17 to the filling station. Upon completion fueling filling, the check valve 7 und thus also the unlockable check vale 17 will close automatically. During retrieval, depending on the internal tank pressure, the liquid cryogenic or gaseous cryogenic fuel will flow due to a pressure difference between the internal tank 1 and the consumer, in dependency on the pressure in the internal tank 1, via the fueling and retrieval line 9 or the retrieval line 16, the internal tank pressure control valve 15, the heat exchanger 11 and the opened shutoff valve 12 from the internal tank 1 and will be heated in the heat exchanger 11. The check valve 7 and the unlockable check valve 17 are thus closed during retrieval. The shutoff valve 12 is only open if the consumer is supplied with fuel.

The fueling path for filling the internal tank 1 between the fueling coupling 6 on the side of the vehicle and the internal tank 1 comprises with the cryogenic check valve 7 and the cryogenic unlockable check valve 17 two cryogenic switching components. The retrieval path for emptying the internal tank 1 between the internal tank 1 and the feed line to the consumer comprises with the cryogenic internal tank pressure control valve 15 a cryogenic switching component and with the electromagnetic shutoff valve 12 a non-cryogenic switching component.

The cryogenic tank 1 may be filled with liquid cryogenic fuel, wherein gaseous cryogenic fuel returns to the filling station.

Following fueling, depending on the heat capacity of the internal tank heat exchanger, there will be retrieved liquid and subsequently gaseous fuel.

Preferably, the check valve 7, the unlockable check valve 17 and the internal tank pressure control valve 15 are arranged at the end of the filler neck 5 on the side of the internal tank and accessible after removal of the fueling coupling 6 on the side of the vehicle. Optionally, the check valve 7, the unlockable check valve 17 and the internal tank pressure control valve 15 are arranged in the space in the fueling direction downstream of the end of the filler neck 5 on the side of the internal tank and connected to the filler neck 5 and accessible after removal of the fueling coupling 6 on the side of the vehicle via the filler neck 5. Optionally, the check valve 7, the unlockable check valve 17 and the internal tank pressure control valve 15 are arranged in a chamber in the fueling direction upstream of the end of the filler neck 5 on the side of the internal tank or at or in, respectively, the fueling coupling 6 on the side of the vehicle and accessible after removal of the fueling coupling 6 on the side of the vehicle 6. Optionally, the check valve 7, the unlockable check valve 17 and the internal tank pressure control valve 15 are arranged in a separate and thermally insulated tubular part, which is connected to the external tank, and accessible via the tubular part.

Preferably, retrieval of liquid cryogenic fuel is carried out via the fueling and retrieval line 9. Optionally, retrieval of liquid cryogenic fuel is carried out via a separate retrieval line between the internal tank 1 and the internal tank pressure control valve 15.

Preferably, retrieval of gaseous cryogenic fuel is carried out via the retrieval line 19. Optionally, retrieval of gaseous cryogenic fuel is carried out via a separate retrieval line between the internal tank 1 and the internal tank pressure control valve 15.

Optionally, an electromechanical shutoff valve will replace the check valve 7.

Optionally, an electromechanical shutoff valve will replace the unlockable check valve 17.

Optionally, an electromechanical 2/2-way valve will replace the mechanical internal tank pressure control valve 15.

Preferably, the shutoff valve 12 is arranged downstream of the heat exchanger, optionally the shutoff valve 12 is arranged upstream of the heat exchanger, preferably in the area of the cryogenic valves.

Optionally, an electromechanical 5/3-way valve or a 4/3-way valve will replace the check valve 7, the unlockable check valve 17 and the internal tank pressure control valve 15, wherein the retrieval line 10 will branch of in the fueling direction downstream or upstream of the way valve.

Optionally, an electromechanical shutoff valve for liquid cryogenic fuel will replace the check valve 7 and a further electromechanical shutoff valve for gaseous cryogenic fuel will replace the unlockable check valve 17 and a cryogenic check valve between the two electromechanical shutoff valves having a flow direction from the gas valve to the liquid valve will replace the internal tank pressure control valve 15 to prevent return of liquid cryogenic fuel to the filling station during fueling, enable retrieval of liquid cryogenic fuel in the case of an opened liquid valve and a closed gas valve and enable retrieval of gaseous cryogenic fuel in the case of an opened gas valve and a closed liquid valve, wherein the retrieval line 10 will branch off in the fueling direction upstream of the liquid valve.

Preferably, fueling is carried out with liquid cryogenic fuel, optionally fueling is carried out with supercritical cryogenic fuel.

The cryogenic tank comprises according to an embodiment variant a cryogenic check valve 7 to guide a fuel flow during fueling from a filling station into the internal tank 1 and a cryogenic unlockable check valve 17 to guide a gaseous fuel flow during fueling from the internal tank 1 to the filling station, wherein the cryogenic unlockable check valve 17 will open due to a pressure upstream of the cryogenic check valve 7 or as a result of a mechanical coupling between the cryogenic check valve 7 and the unlockable cryogenic check valve 17 by the opening a sealing element in the cryogenic check valve 7, wherein the cryogenic check valve 7 and the unlockable cryogenic check valve 17 are opened during fueling and wherein the check valve 7 and the unlockable check valve 17 are closed during retrieval. In addition, the cryogenic tank 100 may comprise a cryogenic electromechanical shutoff valve to guide a fuel flow in the liquid or supercritical aggregate state during fueling from a filling station into the internal tank 1 and a cryogenic electromechanical shutoff valve to guide a fuel flow in the gaseous aggregate state during fueling from the internal tank 1 to a filling station, wherein the cryogenic electromechanical shutoff valves are closed during fueling and wherein optionally a cryogenic electromechanical shutoff valve is opened during retrieval.

According to the invention, there is arranged at least one cryogenic valve to guide the fuel flow during fueling and/or during retrieval within the filler neck. This is preferably arranged in a chamber connected to the filler neck 5 or in a chamber arranged within the filler neck 5 and is accessible upon removal of the fueling coupling 6 on the side of the vehicle. The cryogenic valve may preferably be configured as a cryogenic check valve 7 or a cryogenic electromechanical shutoff valve to guide a fuel flow in the liquid or supercritical aggregate state during fueling from a filling station into the internal tank 1:

The cryogenic tank 100 thus comprises according to a preferred embodiment variant a cryogenic check valve 7 to guide a fuel flow in the liquid or supercritical aggregate state during fueling from a filling station into the internal tank 1, wherein the cryogenic check valve during fueling is opened due to the fuel flow and wherein the cryogenic check valve 7 is closed during retrieval. In addition, the cryogenic tank 100 may comprise a cryogenic electromechanical shutoff valve to guide a fuel flow in the liquid or supercritical aggregate state during fueling from a filling station into the internal tank 1, wherein the cryogenic electromechanical shutoff valve during fueling and optionally during retrieval will be opened.

The cryogenic tank 100 thus comprises according to an embodiment variant a cryogenic check valve 7 to guide a fuel flow in the liquid or supercritical aggregate state during fueling from a filling station into the internal tank 1 and a cryogenic unlockable check valve 17 to guide a fuel flow in the gaseous aggregate state during felling from the internal tank 1 to the filling station, wherein the cryogenic unlockable check valve 17 opens due to a pressure upstream of the cryogenic check valve 7 or as a result of a mechanical coupling between the cryogenic check valve 7 and the unlockable cryogenic check valve 17 due to the sealing element of the cryogenic check valve 7 or another part of the cryogenic check valve 7 suitable for the coupling of components and wherein the cryogenic check valve 7 and the unlockable cryogenic check valve 17 are open during fueling and wherein the cryogenic check valve 7 and the unlockable cryogenic check valve 17 are closed during retrieval. In addition, the cryogenic tank 100 may comprise a cryogenic electromechanical shutoff valve to guide a fuel flow in the liquid or supercritical aggregate state during fueling from a filling station into the internal tank 1 and a cryogenic electromechanical shutoff valve to guide a fuel flow in the gaseous aggregate state during fueling from the internal tank 1 to the filling station, wherein the two cryogenic electromechanical shutoff valves during fueling and optionally a cryogenic electromechanical shutoff valve during retrieval will be opened.

### REFERENCE LIST

1 internal tank
2 external tank
3 insulation chamber
4 insulation
5 filler neck
6 fueling coupling on the side of the vehicle
7 check valve
8 filling line of the fueling coupling
9 fueling and retrieval line
10 retrieval line
11 heat exchanger
12 shutoff valve
13 bottom side
14 top side
15 internal tank pressure control valve
16 retrieval line
17 unlockable check valve
18 return gas line

1-6. (canceled)

7. A cryogenic tank comprising an internal tank to receive a cryogenic fuel, an external tank that delimits an insulation chamber having insulation between the internal tank and the external tank to reduce the heat input into the internal tank and a thermally insulated filler neck configured to accommodate a fueling coupling on the side of the vehicle, wherein the cryogenic tank comprises at least one cryogenic valve arranged within the filler neck and configured to guide the fuel flow during fueling and/or retrieval, which is arranged in a compartment accessible via the filler neck and may be removed upon removal of the fueling coupling on the side of the vehicle.

8. A cryogenic tank according to claim 7, wherein the cryogenic tank comprises an electromechanical check valve configured to guide a liquid or supercritical fuel flow during fueling from a filling station into the internal tank, wherein the electromechanical check valve is open during fueling.

9. A cryogenic tank according to claim 7, wherein the cryogenic tank comprises an electromechanical cryogenic shutoff valve configured to guide a liquid or supercritical fuel flow during fueling from a filling station into the internal tank, wherein the electromechanical cryogenic shutoff valve is open during fueling and optionally during retrieval.

10. A cryogenic tank according to claim 7, wherein the cryogenic tank comprises a cryogenic check valve configured to guide a fuel flow during fueling from a filling station into the internal tank, and a unlockable cryogenic check valve configured to guide a gaseous fuel flow during fueling from the internal tank to the filling station, wherein the unlockable cryogenic check valve opens due to a pressure upstream of the cryogenic check valve or as a result of a mechanic coupling between the cryogenic check valve and the unlockable cryogenic check valve due to the opening of a sealing element in the cryogenic check valve and wherein the cryogenic check valve and the unlockable cryogenic check valve are open during fueling.

11. The cryogenic tank according to claim 8, wherein the cryogenic tank comprises a cryogenic internal tank pressure control valve configured to guide the fuel flow from the internal tank to a consumer, wherein the internal tank pressure control valve, in the case of an internal tank pressure above a determined change-over pressure of the internal tank pressure control valve, enables a retrieval of gaseous or supercritical fluid and wherein the internal tank pressure control valve, in the case of an internal tank pressure below a determined change-over pressure of the internal tank pressure control valve, enables a retrieval of liquid or supercritical fuel.

12. The cryogenic tank according to claim 8, wherein the cryogenic check valve is configured to be pushed into an open position during fueling of the cryogenic tank due to a pressure difference between the filling station and the internal tank.
